(19) United States
(12) Patent Application Publication
(10) Pub. No.: US 2026/0195358 A1
(43) Pub. Date: Jul. 9, 2026

(54) IMPLIED-FUSION OF ENCODINGS OF INCOMPATIBLE DOMAINS

(71) Applicant: Capital One Services, LLC, McLean, VA (US)

(72) Inventor: Samuel SHARPE, Somerville, MA (US)

(73) Assignee: Capital One Services, LLC, McLean, VA (US)

(21) Appl. No.: 19/015,559

(22) Filed: Jan. 9, 2025

(51) Int. Cl. G06F 16/334; G06F 16/34

(52) U.S. Cl. CPC G06F 16/3347; G06F 16/345

(57) ABSTRACT

Methods and systems for improving generation of digests using computer-generated encodings of incompatible domains via implied-fusion are disclosed. For example, in response to receiving a request to generate a digest of a first user's actions of a first user, the system generates a similarity matrix related to a first domain of first user data comprising a set of similarity vectors having a set of first-domain-similarity values between encodings of digests of user actions. The system may then generate a similarity vector related to a second domain of second user data having a set of second-domain-similarity values between encodings of user actions. The system may then determine a first set of similar users to the first user based on the set of second-domain-similarity values. The system then generates a digest of the first user's actions based on a determined set of similar digests corresponding to the first set of similar users.

### BACKGROUND

Summarizing information is beneficial to provide end-users or data analysts a high level view of a dataset without the need to dive into the dataset itself. The advent of artificial intelligence models has made this task possible without requiring a data analyst to manually review the dataset. Leveraging machine learning models to summarize a dataset, however, is not an easy feat - namely, in the context of multimodal data. For example, multimodal data may refer to data that comes from a variety of sources or that capture different contexts or types of information. When one dataset in one mode is related to, or relies on, a dataset of another mode, the challenge of summarizing the datasets is realized as, although the datasets may be similar, they are of different modalities (e.g., domains). With current artificial intelligence models typically being trained on a dataset of a particular mode, the challenge of training an artificial intelligence model to process multiple modes of data concurrently may be infeasible without creating multiple machine learning models to process a respective modality of multimodal data separately. This creates the technical burden of training each machine learning model separately, and then finding a way to somehow relate the outputs of one machine learning model to the other to effectively summarize (or combine) such outputs. These and other drawbacks exist.

### SUMMARY

Methods and systems are described herein for novel uses and/or improvements to generating digests. As one example, methods and systems are described herein for improving generation of digests based on computer-generated incompatible encoded-domains by fusing multimodal data.

As described above, existing systems currently rely on a plurality of machine learning models to process multimodal data. For example, to process multimodal data, existing systems rely on having separate machine learning models each specifically trained on a particular mode (e.g., domain) of data to generate an output. For example, one mode of data may be image data, and another mode of data may be textual data. As yet another example, one mode of data may be textual data associated with a particular context, and another mode of data may be textual data associated with another context. However, by doing so creates the technical burden of creating and training a specific machine learning model for each mode of data that is to be processed. An additional technical burden exists where, because the outputs of each machine learning model are keyed to the specific mode, there needs to be a way to combine the outputs of those machine learning models to produce a desired output. This may be achieved by creating and training another specific machine learning model to generate an output (e.g., a summary) based on the outputs of the other machine learning models. By doing so, however, further exacerbates the problem of using a large amount of computational resources (computer processing and memory resources) to implement such multi-machine-learning-model architecture.

One way to overcome this would be by fusing the multimodal data. For example, multimodal data fusion may refer to the integration, combination, or otherwise “linking of” one mode of data to another mode of data. Multimodal data fusion may be achieved in a variety of ways to include early fusion (feature-level fusion), late fusion (decision-level fusion), or hybrid fusion (e.g., intermediate-level fusion). For instance, early fusion may pair features of a dataset in one modality to other features of another dataset in another modality. When such features are paired, a single machine learning model is enabled to learn the meaningful relationships between the features of the different modalities to produce a meaningful output. However, early fusion relies on a large corpus of training data of each mode of the multimodal data to be processed. For example, given the complexity and inherent nuances of “linking” or fusing different modalities of data together, machine learning models must be provided with a large amount of accurately labeled, fused, multimodal data to learn meaningful patterns between the different modes of data. To control what patterns and relationships the machine learning model may learn during machine learning model training routines, the multimodal data (or features thereof) must be manually and accurately labeled. Without this large corpus of training data (e.g., 10000, 50000, 100000 examples etc.), the machine learning model may underfit to new input data. Given such underfitting, where the multimodal data is limited or unavailable, traditionally fusing the multimodal data may waste computational resources involved as results (or other outputs) generated by the machine learning model may be inaccurate or meaningless.

To overcome these technical deficiencies in adapting artificial intelligence models for this practical benefit, methods and systems disclosed herein may improve generation of textual digests (e.g., summaries) based on encodings of incompatible domains via implied-fusion of multimodal data. For example, the system may leverage an implied relationship between one mode (e.g., domain) of data and another mode (e.g., domain) of data to effectively fuse (or generate an implied-based-fusion) of multi-modal data. For instance, by generating a similarity vector related to one mode of data, and using results of the similarity vector to determine a similarity to other similarity vectors of a similarity matrix related to a second mode of data, the system reduces the technical burdens associated with traditional fusion of multimodal data. Namely, the system need not require a large corpus of manually, accurately labeled, paired multimodal data, but rather may use an implied-fusion technique to effectively fuse limited multimodal data.

For example, in the context of using artificial intelligence models to summarize textual data (e.g., generate digests) based on multimodal data, the artificial intelligence model must be trained on a large corpus of multimodal data. For example, the multimodal data may comprise a first mode of user data that includes summaries (e.g., digests) of user actions and a second mode of user data that includes a set of user actions (that correspond to those summaries). Although the two modes of data are related to one another (e.g., one being a summary, the other being actions to which the summary is based on), fusing such modes, or domains, of data is difficult due to the reasons outlined above. However, where a limited amount of multimodal data exists or is available, training the artificial intelligence model to generate an accurate summary of a new user's actions may prove difficult or be inaccurate due to underfitting.

To overcome this, the system may generate a similarity matrix related to a first modality (e.g., first domain) of first user data that comprises a set of similarity vectors. Each similarity vector of the set of similarity vectors may include first-modality-similarity metrics (e.g., first-domain-similarity values) between encodings (e.g., embeddings) of the first user data. For example, the first-modality-similarity metrics may be similarity metrics between embeddings of summaries between sets of user action of a set of first users. By embedding the user data and generating similarity metrics between the embeddings of the first user data (e.g., of the first modality), the system may transform the first user data into a standardized format. In response to receiving a request to generate a summary (e.g., digest) of a new user's actions, the system may generate a similarity vector that is related to a second modality (e.g., second domain) of user data. For example, the second modality of user data may be sets of user's actions. The generated similarity vector may include second-modality-similarity metrics (e.g., second-domain-similarity values) between (i) an embedding of the new user's actions and (ii) embeddings of sets of users'actions corresponding to the set of first users. In other words, the similarity matrix related to the first modality may indicate similarity-metrics between summaries (e.g., summaries of sets of user actions, digests of sets of user actions) and the similarity vector related to the second modality may indicate similarity-metrics between the sets of user actions when compared to a new user (e.g., new input data). Under the implied relationship that users that complete similar actions have similar summaries, the system may perform an implied-fusion of the first modality to the second modality (and vice versa).

For example, the system may determine from the generated similarity vector related to the second modality, a set of similar users that are similar to the new user based on the second-modality-similarity metrics (e.g., which users of the first set of users are similar to the new user based on the actions that the first set of users have performed). The system may then use a similarity matrix related to the first modality to determine similarity vectors (e.g., of the similarity matrix) that correspond to the set of similar users. Since the similarity matrix is related to the first modality, and the set of similar users stems from the second modality, the system uses implied-fusion to determine a set of summaries that may correspond to the new user's actions. For example, the system determines a set of similar summaries based on the first-modality similarity metrics of the similarity matric that satisfy a threshold similarity metric.

Using the determined set of similar summaries (e.g., digests), the system provides the set of similar summaries to an artificial intelligence model trained to generate an overall summary (e.g., digest) of the set of similar summaries. For example, the system may provide the set of similar summaries to a Large Language Model (LLM) to summarize the set of similar summaries (e.g., due to the inherent nature of LLM's being able to efficiently process textual data). By doing so, the system overcomes the technical burdens of requiring (i) multiple machine learning models being specifically trained on respective modalities of multi-modal data, (ii) large amount of labeled, fused, multi-modal data, and (iii) the need for a machine learning model specifically trained to aggregate results of differing outputs of multimodal data. Additionally, by leveraging implied-fusion, the system may effectively transform multiple modalities of multimodal data into a single standardized mode of data via the similarities of embeddings of the separate modes. Accordingly, the methods and systems provide accurate textual summary generation of user actions.

In some aspects, methods and systems for generating digests based on computer-generated encodings of incompatible domains via implied fusion are disclosed. In response to receiving a request to generate a summary of a first user's actions of a first user over a first secure computing network, the system generates a first encoding of the first user's actions via an encoder model. The system generates a similarity matrix related to a first domain of first user data comprising a set of similarity vectors, wherein each similarity vector of the set of similarity vectors comprises a set of first-domain-similarity values between (i) a first encoded-domain of a first set of encodings and (ii) a second encoding of the first set of encodings, where the first encoding is based on a digest of a first user's actions of a first set of users and the second encoding is based on a digest of a second user's actions of the first set of users. In response to generating the similarity matrix, the system generates a similarity vector related to a second domain of second user data comprising a set of second-domain-similarity values between (i) the first encoding of the first user's actions and (ii) a second encoding of a second set of encodings that correspond to a respective user's actions of the first set of users. The system determines, from the similarity vector related to the second domain, a first set of similar users to the first user based on the set of second-domain-similarity values. The system selects, based on the first set of similar users to the first user, a set of similarity vectors from the similarity matrix related to the first domain that correspond to each similar user of the first set of similar users to the first user based on the set of second-domain-similarity values. The system determines a set of similar digests, based on the selected set of similarity vectors, wherein the set of similar digests are associated with a first-domain-similarity value satisfying a first threshold similarity value. The system generates the digest of the first user's actions based on providing the set of similar digests as input to an artificial intelligence model trained to generate digests of textual data.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for providing a digest of a user's actions, in accordance with one or more embodiments.

FIGS. 2A-2C shows an illustrative diagram for determining similar digests that correspond to a user, in accordance with one or more embodiments.

FIG. 3 shows illustrative components for a system used to improve generation of digests based on computer-generated encodings of incompatible domains, in accordance with one or more embodiments.

FIG. 4 shows a flowchart of the steps involved in improving generation of digests based on computer-generated encodings of incompatible domains, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

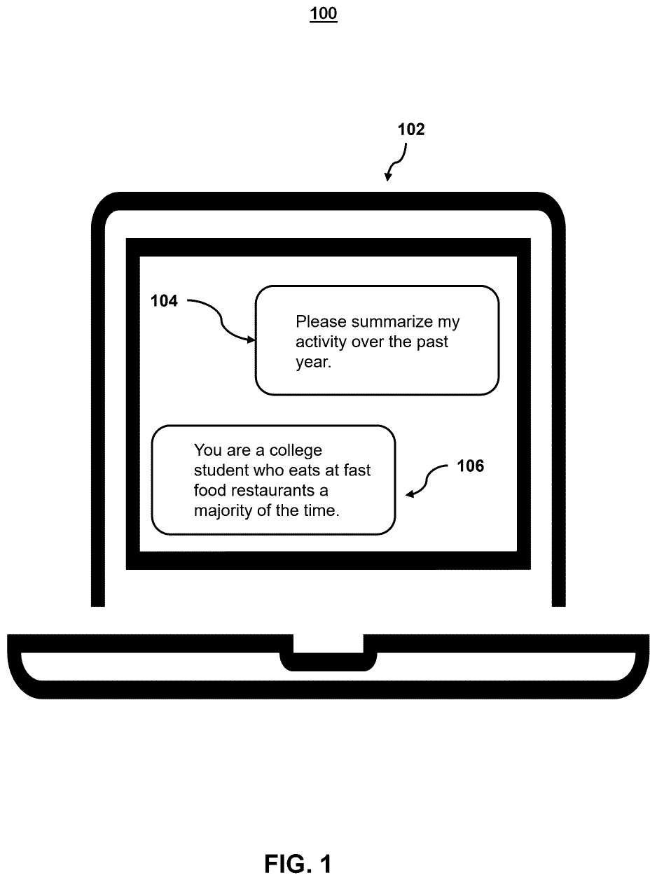

FIG. 1 shows an illustrative diagram for providing a digest of a user's actions, in accordance with one or more embodiments. For example, diagram 100 may indicate a client device 102, a user request 104, and a summary 106. For example, FIG. 1 illustrates a user providing a user request 104 on a client device 102 to generate a summary 106 (e.g., a digest) of the user's actions. For example, the user request 104 may be provided by the user to which a summary 106 is to be generated for. Additionally or alternatively, the user to which a summary 106 is to be provided for may not initiate the user request 104. For example, a user account provider may provide the user request 104 on behalf of the user (or for the user) to generate a summary 106 of the user's actions. For example, a data analyst may request that a summary 106 is to be generated based on the user's actions. The user's actions may include a set of actions that the user has performed with respect to a time period. For example, the set of actions may be account activity data (e.g., health account activities, exercise routines, financial account activities, travel activities, or other account-related activity data that the user has performed).

The account activity data may include a sequence of actions. For example, the sequence of actions may preserve timestamps at which the user has performed respective actions. Additionally, the time period may be for a predetermined amount of time (one hour, five hours, one day, one week, one month, six months, one year, five years, 10 years, etc.). In some embodiments, the time period may be for the entirety of the account associated with the user being active. For example, where the user created an account on a given date/time, where the time period is for the entirety of the account being active, the time period may be between the time that the user created the account and a current time (e.g., to which summary 106 is being generated).

The set of actions (or alternatively, the account activity data) may be in a given format. For example, the format may be of textual data, image data, biometric data, video data, audio data, or other data format. As such, the methods and systems described herein are not limited to textual data, but may generate summaries (or other outputs) in a format that corresponds to the format of the set of actions.

In some embodiments, a user may not have a summary that summarizes the user's set of actions. As described above, existing systems experience technical difficulties when attempting to summarize a set of user's actions due to the requirement of multiple specially trained machine learning models, limited training datasets, or other technical problems. It is advantageous, however, to provide an accurate summary of a set of user's actions as it may provide the user or data analyst an overview of the user's actions without the need to manually parse the set of user's actions and develop an error-prone opinion-based summary of the user's set of actions. As such, the system may generate a summary of a user's actions based on an implied-fusion of multimodal data corresponding to other user's (i) summaries and (ii) sets of actions.

The system may be used to generate a digest of a user's actions. In disclosed embodiments, a digest may be an overview of data that condenses the data to capture main ideas, points, or essential information. For example, a digest may be a summary of a user's actions. For example, a summary may be a rephrased, reorganized, condensed version, reformatted version, or new version of data that is based on one or more datasets. In some embodiments, a summary may comprise a rephrased version of a set of user actions. In some embodiments, a summary may comprise a compressed version of a dataset. In some embodiments, a summary may comprise a description of a set of actions of a user in a textual format. In some embodiments, a summary may comprise an image based on a set of images. In some embodiments, a summary may comprise an audio file based on a set of audio files. In some embodiments, a summary may comprise a generalized representation of biometric data based on a set of captured biometric data. As such, a summary may be a representation of data that is based on a dataset to provide an overview, description, or new data that corresponds to a respective dataset.

The system may use multimodal data. In disclosed embodiments, multimodal data may refer to data that comes from a variety of sources or that capture different contexts or types of information. In some embodiments, multimodal data may refer to data that are of different domains. For example, a domain may refer to a logical group of data that shares a common characteristic. For example, the modes (e.g., domains) of the multimodal data may indicate a source of data, a format of data, a type of data, a structure of data, a context associated with data, a characteristic of data, or other modality-related information. For instance, the modes of data may include text, images, audio, video, sensor, biological, or other data. In some embodiments, although a type of dataset may be similar to another dataset (e.g., a textual summary, and a set of user actions described in text form), the modes of the dataset may nonetheless be different. For example, because the textual summary indicates a summary (e.g., a string, set of strings, etc.) and the set of user actions indicates a set (e.g., of strings, set of string, sets of characters) of data, the modes of such data may be different from one another due to the contextual information that they are associated with. For example, the context may refer to circumstances, conditions, or background information associated with a dataset. For instance, referring to the example above, because the summary indicates a summary of actions (e.g., one context) and the set of user actions indicate the actions themselves (e.g., a second context), the summary and set of actions may be of different modalities of data.

The system may generate similarity metrics. In disclosed embodiments, a similarity metric may quantify the similarity between two objects (e.g., vectors, encodings, embeddings, sets, strings, documents, images, audio files, video files, biometric data, etc.). For example, the system may generate a similarity metric between encodings of data. For example, an encoding may refer to an embedding (e.g., quantifiable, numerical, alphanumeric representations of data). For instance, the system may generate a similarity metric between a first embedding of data and a second embedding of data. In some embodiments, a similarity metric (or similarity metrics) may be symmetrical similarity metrics or asymmetrical similarity metrics. For example, a symmetrical similarity metric may be a Euclidean distance, cosine similarity, jaccard index, or other symmetrical similarity metric. As another example, an asymmetrical similarity metric may be Kullback-Leibler (KL) divergence, Directed Hausdorff distance, or other asymmetrical similarity metric.

The system may be used to generate a similarity vector. For example, a similarity vector may be a vector or an array that comprises a set of similarity values of a similarity metric between one object and a set of other objects. For example, each element in the similarity vector may correspond to the similarity between a reference object and one of the other objects. For instance, each element may be a similarity metric (e.g., similarity value of a given similarity metric) between the reference object and one of the other objects. In some embodiments, the system may generate a similarity vector between a first embedding (e.g., encoding) of a first user's action (e.g., a reference object) and a second embedding (e.g., encoding) of each of a second user of a set of second user's actions (e.g., another object(s)). In some embodiments, the system may generate a set of similarity vectors (e.g., for a similarity matrix). For example, each vector of the set of similarity vectors for the similarity matric may be a similarity vector between a first embedding of a first summary of a user of a first set of users (e.g., a reference object) and a second embedding of each of a second summary of a second user of the first set of users (e.g., another object(s)). In some embodiments, the system may generate a similarity vector for a given modality (e.g., domain) of user data. For example, the system may generate a similarity vector that is related to sets of user actions. As another example, the system may generate a set of similarity vectors (e.g., for a similarity matrix) that is related to summaries of users.

The system may be used to generate a similarity matrix. For example, a similarity matrix may be a matrix that is used to represent a similarity between pairs of objects. In some embodiments, a similarity matrix may comprise a set of similarity vectors. In some embodiments, a similarity matrix may be a square matrix (e.g., an N×N matrix where N is the number of objects in a dataset). The similarity matrix may comprise similarity metrics of the same type. For example, the similarity matrix may be a cosine similarity matrix where each similarity metric included in the similarity matrix are cosine similarity metrics. In some embodiments, the system may generate a similarity matrix for a given modality of user data. For example, the system may generate a similarity matrix that is related to summaries of a set of users.

The system may use implied-fusion of multimodal data. For example, implied-fusion of multimodal data may refer to a novel method of fusing data of one modality to another modality. In some embodiments, implied-fusion is associated with an implied relationship between modalities of data. For example, in disclosed embodiments, the implied-fusion described herein may be based on the implied relationship that users that have similar datasets have similar summaries of those datasets. For example, users that perform similar sets of actions with respect to other users have similar summaries of those actions. By doing so, the system may leverage limited machine-learning-model-based methods for fusing multimodal data via similarity matrices and similarity vectors corresponding to respective modalities of data to generate new summaries. In some embodiments, the implied relationship however, may be of different contexts.

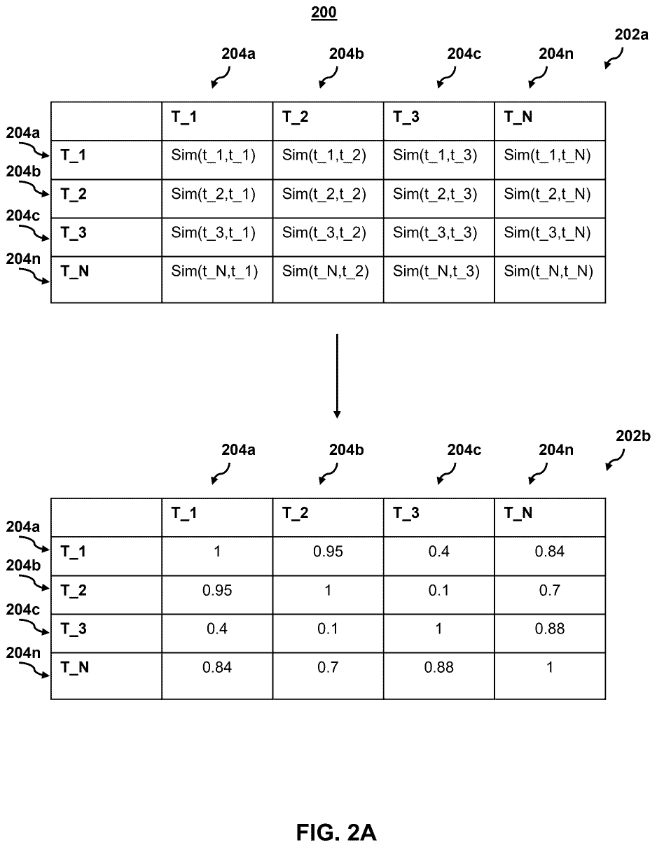

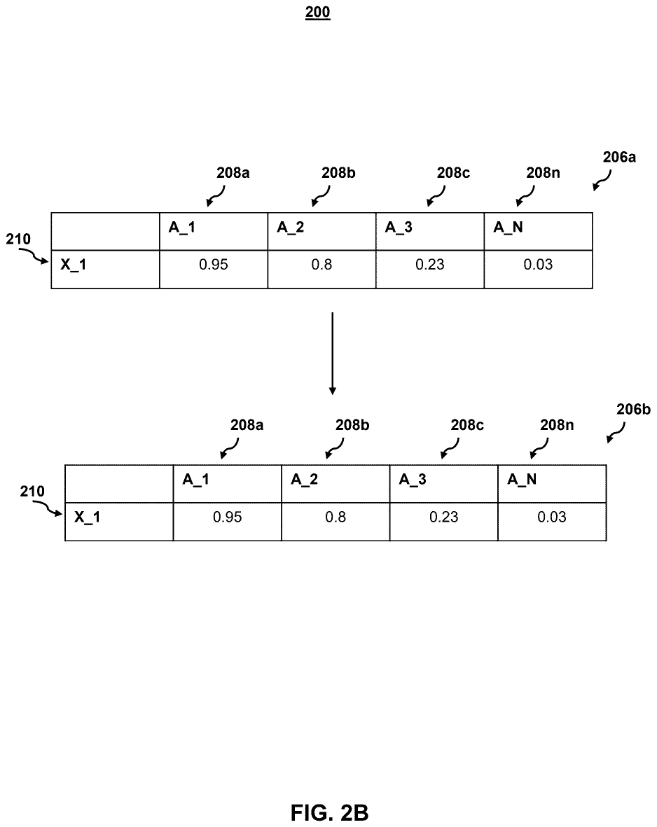

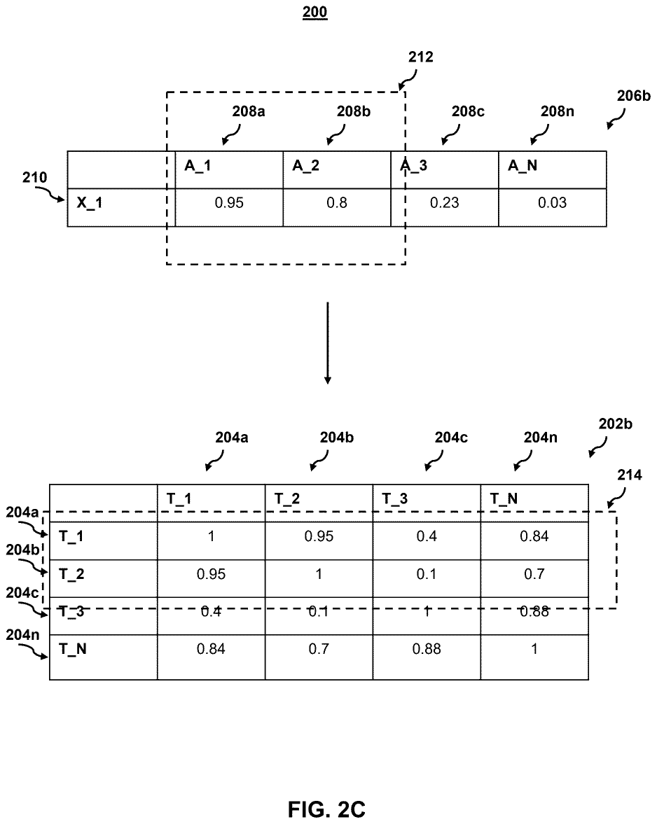

FIGS. 2A-2C shows an illustrative diagram for determining similar digests that correspond to a user, in accordance with one or more embodiments. For instance, FIGS. 2A-2C shows a diagram 200 that indicates a similarity matrix 202 and a similarity vector 206. The system may use similarity vector 206 to determine a set of similar users 212, which may then be used to determine a set of similarity vectors 214. For example, referring to FIG. 2C, when a new summary for a new user 210 is to be generated, the system may determine a set of similar users 212 from similarity vector 206 to determine a set of similarity vectors 214 from the similarity matrix 202 to then determine a set of similar summaries (e.g., based on the set of similarity vectors 214) that leverages implied-fusion of multimodal data. For example, under the implied relationship that users that are associated with similar actions have similar summaries of those actions, when a new summary for a new user to be generated, the system may use the similarity vector 206 and the similarity matrix 202 to fuse data of one modality to data of another modality. Using this fused data, as will be described later, the system may determine a set of similar summaries to be provided as input to an artificial intelligence model to generate a new summary based on the set of similar summaries, thereby reducing the amount of computational resources associated with generating summaries based on a multiple, modality-specific machine learning models.

Referring to FIG. 2A, FIG. 2A shows a similarity matrix 202. The first similarity matrix 202a is an abstracted view of second similarity matrix 202b. The first similarity matrix 202a may correspond to second similarity matrix 202b, with the difference being that second similarity matrix 202b includes a numerical representation of similarity metrics of first similarity matrix 202a. In other words, first similarity matrix 202a is shown as an example of how similarity metrics (e.g., Sim(t_1,t_1), Sim (t_1,t_2), . . . Sim (t_N, t_N)) may be used to generate second similarity matrix 202b comprising a numerical representation of the similarity metrics.

Similarity matrix 202 may be related to a first modality of multimodal data. For example, the first modality of user data may be a set of summaries, where each summary of the set of summaries is associated with a respective user of a first set of users. For instance, the system may store a set of summaries, where each summary summarizes a set of user actions. In some embodiments, the set of summaries may be labeled with user identifiers that indicate a user of the first set of users to which the summary corresponds to. Additionally or alternatively, the set of summaries may be labeled with an action identifier that indicates a set of actions to which the summary is based on.

In some embodiments, prior to generating similarity matrix 202, the system may embed (e.g., via an embedding model) each summary of the set of summaries. The embedded set of summaries may then be used to generate similarity matrix 202. For example, similarity matrix 202 may include a set of similarity vectors, where each similarity vector corresponds to a user of the first set of users, and where each similarity vector includes first-modality-similarity (e.g., first-domain-similarity) metrics (e.g., values) of embeddings (e.g., encodings) of the first set of users. For instance, similarity matrix 202 may be a square matrix, where the rows and the columns of similarity matrix 202 corresponds to a respective user of the first set of users. For instance, user 204 may be a user identifier corresponding to a given user. Each user may have their own similarity vector that makes up the similarity matrix 202. For instance, first user 204a has a similarity vector that includes first-modality-similarity metrics of embeddings of first user 204a's summary, second user 204b's summary, third user 204c's summary, and n-th user 204n's summary. In other words, each user 204 corresponds to a similarity vector that includes a respective first-modality-similarity metric between each of the users of users 204a-204n. In some embodiments, the similarity vectors corresponding to a user may be row based or column based when the first-modality-similarity metrics are symmetric similarity metrics (e.g., the similarity between object A and object B is the same as the similarity between object B and object A). In other embodiments, where the first-modality-similarity metrics are asymmetric similarity metrics, the similarity vectors corresponding to a user may be one of row based or column based (e.g., since the asymmetric similarity between object A and object B is different from that of the asymmetric similarity between object B and object A).

As an example, referring to second similarity matrix 202b, a first-modality-similarity metric between first user 204a's summary embedding and first user 204a's summary embedding has a value of “1.” It should be noted, that although a numerical representation of the first-modality-similarity metric is shown, that other values may exist such as percentages, ratios, alphanumeric values, or other values that denote a similarity metric, in accordance with one or more embodiments. As another example, another first-modality-similarity metric between first user 204a's summary embedding and second user 204b's summary embedding is “0.95.” For instance, the value of 0.95 may indicate that the respective embeddings are 95% similar with respect to each other. As such, second similarity matrix 202b may comprise a set of similarity vectors for each user of the first set of users, which further includes first-modality-similarity metrics between each of the respective users of the first set of user's embedded summaries (e.g., of respective user actions). For instance, a first similarity vector of second similarity matrix 202b that corresponds to the first user 204a may include (i) a first-modality-similarity metric between first user 204a and first user 204a's summaries of user actions, (ii) a first-modality-similarity metric between first user 204a and second user 204b's summaries of user actions, (iii) a first-modality-similarity metric between first user 204a and third user 204c's summaries of user actions, and (iv) a first-modality-similarity metric between first user 204a and n-th user 204n's summaries of user actions.

Referring to FIG. 2B, FIG. 2B shows a similarity vector 206. The first similarity vector 206a is an abstracted view of second similarity vector 206b. The first similarity vector 206a may correspond to second similarity vector 206b, with the difference being that second similarity vector 206b includes a numerical representation of similarity metrics of first similarity vector 206a. In other words, first similarity vector 206a is shown as an example of how similarity metrics (e.g., Sim(X_1,A_1), Sim (X_1,A_2), . . . Sim (X_N, A_N)) may be used to generate second similarity vector 206b comprising a numerical representation of the similarity metrics.

Similarity vector 206 may be related to a second modality of multimodal data. For example, the second modality of user data may be sets of sets of user actions that correspond to the first set of users, as well as a set of user actions corresponding to a new user 208 (e.g., to whom a summary is to be generated). For instance, the system may store the sets of sets of user actions, where each set of user actions correspond to actions of a respective user. In some embodiments, the set of sets of user actions may be labeled with user identifiers that indicate a user of the first set of users to which the respective set of actions correspond to, and the new user's set of actions. The first set of users may be the same set of users as those in the similarity matrix (FIG. 2A).

In some embodiments, prior to generating similarity vector 206, the system may embed (e.g., via an embedding model) each set of user actions corresponding to the first set of users, as well as a new user's set of actions (e.g., the user to whom a summary is to be generated). The embedded sets user actions may then be used to generate similarity vector 206. For example, similarity vector 206 may correspond to the new user to whom the summary to be generated, and similarity vector 206 includes second-modality-similarity (e.g., second-domain-similarity) metrics (e.g., values) of embeddings (e.g., encodings) between (i) the new user's set of actions and (ii) each respective user's set of actions of the first set of users. For instance, similarity vector 206 may be a similarity vector that measures similarities of sets of user actions between the new user 210 to which a summary is to be generated for, and each of the first set of users 208a-208n. For instance, the first set of users 208a-208n may correspond respectively to the first set of users 204a-204n of FIG. 2A. That is, to employ implied-fusion, the system leverages the relationship that users that have similar sets of actions have similar summaries. As such, the system computes second-modality-similarity metrics between (i) new user 210's set of actions and (ii) each of the first set of users 208a-208n's sets of actions.

In some embodiments, the second-modality-similarity metrics may be symmetric modality metrics (e.g., the similarity between object A and object B is the same as the similarity between object B and object A). In other embodiments, the second-modality-similarity metrics are asymmetric similarity metrics (e.g., asymmetric similarity between object A and object B is different from that of the asymmetric similarity between object B and object A).

As one example, referring to second similarity vector 206b, a second-modality-similarity metric between new user 210 set of actions embedding and first user 208a's set of actions embedding has a value of “0.95.” It should be noted, that although a numerical representation of the second-modality-similarity metric is shown, that other values may exist such as percentages, ratios, alphanumeric values, or other values that denote a similarity metric, in accordance with one or more embodiments. As another example, another second-modality-similarity metric between new user 210 set of actions embedding and second user 208b's set of actions embedding is “0.8.” For instance, the value of 0.8 may indicate that the respective embeddings are 80% similar with respect to each other. As such, second similarity vector related to the second modality that corresponds to new user 210 may comprise (i) a second-modality-similarity metric between new user 210 and first user 208a's embeddings respective sets of user actions, (ii) a second-modality-similarity metric between new user 210 and second user 208b's embeddings respective sets of user actions, (iii) a second-modality-similarity metric between new user 210 and third user 208c's embeddings respective sets of user actions, and (iv) a second-modality-similarity metric between new user 210 and n-th user 208n's embeddings respective sets of user actions.

Referring to FIG. 2C, FIG. 2C shows determining a set of similar summaries. For example, second similarity vector 206b related to the second-modality of user data may be used to determine a set of similarity vectors 214 from the second similarity matrix 202b related to the first-modality of user data. For example, employing implied-fusion of multimodal data leverages the relationship that users that have similar sets of actions have similar summaries. Contrary to existing systems that rely on a large corpus of manually and accurately labeled multimodal data that is then paired (e.g., fused), and subsequently provided to specially trained artificial intelligence models, implied-fusion reduces the technical deficiencies associated with such existing systems by leveraging meta-similarity-based fusion of modalities. For instance, while existing systems require a large corpus of manually labeled multimodal data, implied-based fusion may be advantageous where the multimodal dataset is limited. Additionally, where existing systems use specially trained, multi-machine-learning-model architectures, implied-fusion reduces the amount of computational resources traditionally required as similarities between optimized multimodal data (e.g., embeddings) are determined and serve as a basis for generating outputs that link one modality of data to another modality of data.

In some embodiments, the system may determine a first set of similar users to the new user (e.g., to whom the summary is to be generated for). For example, the system may determine, from the similarity vector 206, a first set of similar users to the new user 210 based on the second-modality-similarity metrics. In some embodiments, the system may select second-modality-similarity metrics that satisfy a threshold second-modality similarity metric. For example, where the second-modality-similarity metric is 0.75, the system may select the first set of similar users 212 (e.g., first user 208a and second user 208b), because the first user 208a and the second user 208b's second-modality-similarity metrics are greater than or equal to the threshold second-modality similarity metric. In other embodiments, the system may select the first set of similar users 212 based on a count condition (e.g., top 2, top 5, top N, etc.). In some embodiments, the system may select the first set of similar users 212 based on other conditions or thresholds, in accordance with one or more embodiments. The system may then identify, based on user identifiers associated with the first set of similar users 212, the users that correspond to the selected first set of similar users 212 to be used in selecting a set of similarity vectors 214 from the similarity matrix 202.

For example, the system may use the determined first set of similar users 212 to select the set of similarity vectors 214. For instance, where the first set of similar users 212 includes first user 208a and second user 208b, the system may select the set of similarity vectors 214, because first user 208a corresponds to first user 204a and second user 208b corresponds to second user 204b. For instance, the system may use the user identifiers associated with both the second similarity vector 206b and the second similarity matrix 202b to retrieve the set of similarity vectors 214 that correspond to the first set of similar users 212. By doing so, the system effectuates implied fusion of the second modality to the first modality of user data by (i) using the second similarity vector 206b that is related to the second modality of user data (e.g., the sets of user actions) and (ii) using the second similarity matrix 202b that is related to the first modality of user data (e.g., the summaries corresponding to respective users of the first set of users) to then be used obtain a set of similar summaries, and generate a summary based on the obtained set of similar summaries for new user 210.

For example, the system may use the set of similarity vectors 214b to retrieve a set of similar summaries. For example, the system may determine, based on the selected set of similarity vectors, where the set of similar summaries are associated with a first-modality-similarity metric satisfying a threshold similarity metric. Additionally or alternatively, the set of similar summaries may be associated with a first-modality-similarity metric satisfying a count condition (e.g., top 2, top 5, top 10, top 100, etc.). As an example, the system may determine, based on the selected set of similarity vectors 214, summaries that have a first-modality-similarity metric that satisfy a threshold similarity metric. For instance, where the threshold similarity metric is 0.8, the system may retrieve (e.g., from a database), the summary that corresponds to first user 204a, second user 204b, and n-th user 204n because each first-modality-similarity metric corresponding to such respective users are 1, 0.95, and 0.84. As such, the system may use user identifiers associated with the first user 204a, second user 204b and n-th user 204n to obtain the set of similar summaries. For example, the system may access a database storing the summaries and retrieve the summary corresponding to first user 204a, second user 204b, and n-th user 204n. The system may then provide the set of similar summaries to an artificial intelligence model to generate a summary for new user 210. By doing so, the system overcomes the technical disadvantages associated with traditional multimodal data fusion and the disadvantages of creating and training multiple machine learning models specifically keyed to given modalities by leveraging similarity-metric-based implied fusion of multimodal data.

In some embodiments, the system may remove duplicates. For example, because the similarity matrix 202 is a square matrix, and where symmetrical similarity metrics are used, duplicates may exist. As an example, the first-modality-similarity metric of first user 204a and second user 204b is the same as the first-modality-similarity metric of second user 204b and first user 204a. Since both of these same first-modality-similarity metrics exist within the set of similarity vectors 214b, the system may remove such duplicates, or ignore (or not consider) such duplicates when obtaining the set of similar summaries that correspond to such users. By doing so, the system may reduce utilization of unnecessary computational resources (computer memory and computer processing power) required to identify and process the set of similar summaries that correspond to those duplicated first-modality-similarity metrics.

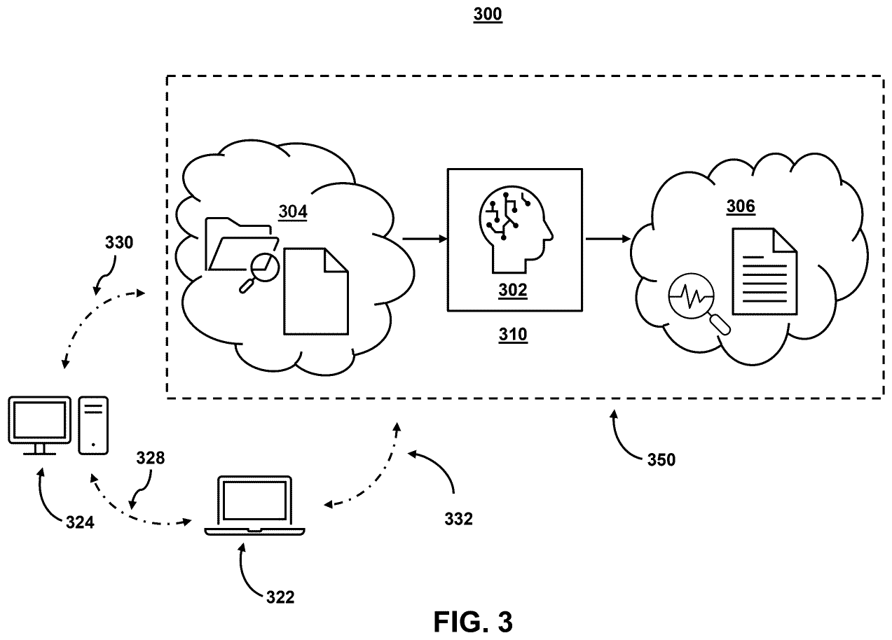

FIG. 3 shows illustrative components for a system used to improve generation of digests based on computer-generated encodings of incompatible domains, in accordance with one or more embodiments. For example, FIG. 3 may show illustrative components for generating summaries for users. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

System 300 may operate as a secure computing network. For example, a secure computing network may be a computer network that is secured (e.g., protected) via one or more firewalls, antivirus software, encryption protocols, encryption/decryption algorithms, intrusion detection and prevention systems, authentication mechanisms, or the like. For example, the secured computing network may encrypt data between components of system 300 to enhance cybersecurity of user data (e.g., user actions, generating digests, generating summaries, etc.).

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data) For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include client device 102 (FIG. 1), similarity matrix 202 (FIGS. 2A-2C), or similarity vector 206 (FIGS. 2A-2C). Cloud components 310 may access a user database storing user data, such as summaries that respectively correspond to users and sets of user actions corresponding to the users, embedding database storing embeddings of sets of user actions and user summaries, model database storing artificial intelligence models, similarity metric threshold database storing threshold similarity metrics, a condition database storing conditions to which one or more embodiments depend on, prompt database storing artificial intelligence model prompts, or other databases.

Cloud components 310 may include model 302, which may be a machine learning model, artificial intelligence model, etc. (which may be referred collectively as “models” herein). In some embodiments, model 302 may be an encoder model. In some embodiments, model 302 may be an LLM. In some embodiments, model 302 may be an embedding model. In some embodiments, model 302 may be a transformer model.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., an embedding of a summary, an embedding of a set of user actions, an aggregated summary based on a set of summaries, etc.)

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., (e.g., an embedding of a summary, an embedding of a set of user actions, an aggregated summary based on a set of summaries, etc.)

In some embodiments, the model (e.g., model 302) may automatically perform actions based on outputs 306. In some embodiments, the model (e.g., model 302) may not perform any actions. The output of the model (e.g., model 302) may be used to generate a new summary for a user, generate a summary based on a set of summaries, transmit notifications to users, transmit notifications to data analysts, store information (e.g., summaries, embeddings, etc.) in a database, or other actions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

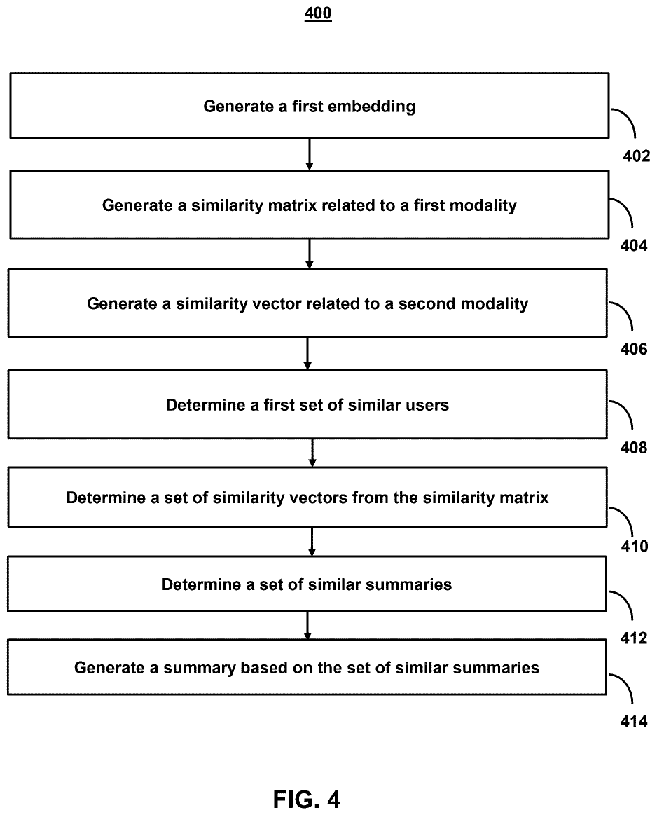

FIG. 4 shows a flowchart of the steps involved in improving generation of digests based on computer-generated encodings of incompatible domains, in accordance with one or more embodiments. For example, the system may use process 400 (e.g., as implemented on one or more system components described above) in order to generate a summary for a new user.

At step 402, process 400 (e.g., using one or more components described above) generates a first embedding (e.g., encoding). For example, in response to receiving a request to generate a summary (e.g., a digest) of a first user's actions of a first user over a first secure computing network, the system may generate a first embedding of the first user's actions via an artificial intelligence model (e.g., model 302 (FIG. 3)). The first user may be a user where no summary of their actions (e.g., account activity data, biometric data, health data, etc.) exists. As such, the user (or other entity, such as a data analyst) may transmit a request to generate a summary for the user. The request may be received by the system and the system may generate an embedding of the user's actions. For instance, the system may provide the set of actions of the user (e.g., a sequence of actions) to an encoder model (or other embedding model) trained to generate an embedding of a set of actions. The encoder model may be any encoder model (e.g., Recurrent Neural Network (RNN), Long Short-Term Memory (LSTM) Network, Convolutional Neural Network (CNN), or Transformer model. By doing so, the system may reduce the amount of computer memory required to store the set of actions, and rather store the embedding of the user's actions.

In some embodiments, the system may obtain first user data of a first modality and second user data of a second modality. For example, as described above, modes of multimodal data may refer to data that comes from a variety of sources or that capture different contexts or types of information. In some embodiments, the first modality and the second modality may indicate characteristics of a dataset. For example, modalities may refer to a category, format, dimensionality, size, sample rate, type, or other modality characteristics. As discussed above, when training or otherwise using an artificial intelligence model with multimodal data, many challenges occur due to a dataset of one modality being different than that of another modality. For example, where the first user data is of a first modality (e.g., first format) and the second user data is of a second modality (e.g., second format), the modalities may be different from one another. Because these modalities are different, they are not fusible and able to be used in their “raw” form to train or be accepted by an artificial intelligence model. Therefore, the system may process the data to enable the data of the first modality and the second modality to become fusible data. In this way, the system may bridge the gap between otherwise raw, infusible, data to be used to obtain an output from a single artificial intelligence model.

The system may obtain first user data that is of a first modality (e.g., summaries of sets of user actions) and second user data that is of a second modality (e.g., sets of user actions). For example, the first user data may be a set of summaries, where each summary of the set of summaries corresponds to a set of actions that a user has performed. As another example, the second user data may be sets of sets of user actions (e.g., sequences of user actions) that a user has performed. As such, the first modality may be related to the second modality, but are nonetheless different modes of data because the context that they respectively capture are different (e.g., summaries vs. sets of actions). In some embodiments, the first user data and the second user data may involve the same users. For example, each user of the first user data may correspond (e.g., match) to each user of the second user data. In other words, the first user data may indicate the summaries that correspond to a respective set of user's actions of the second user data. In some embodiments, the first user data may be stored separately from the second user data (e.g., in different databases) to prevent obfuscation of storing data of different modalities. However, in some embodiments, the first user data may be stored together with the second user data (e.g., in the same database) for easier retrieval.

In some embodiments, first user data and the second user data may include a user identifier label. For example, each summary of the first user data may be labeled with a user identifier that uniquely identifies the user to which the summary corresponds. Likewise, each set of actions of the second user data may also be labeled with a user identifier that uniquely identifies the user to which the set of actions corresponds. By doing so, the system may use such user identifier labels to (i) determine a set of similar users and (ii) determine a set of similar summaries (e.g., when employing implied-fusion of multimodal data).

In one use case, the system may receive a request to generate a summary of a user's financial account activity. However, the system may not have a summary previously generated for the user, but has access to the user's financial account activity. As such, the system may generate an embedding of the user's financial account activity. As will be explained later, the embedding may be used to determine a set of similar users (e.g., based on other user's financial account activity data). Using implied-fusion of multimodal data, the set of similar users may be used to determine a set of similar summaries (e.g., summaries corresponding to the set of similar users) that is then used as a basis for generating a new summary for the user. By doing so, the system overcomes the technical disadvantages associated with traditional multimodal fusion by employing implied-fusion (e.g., users with similar actions have similar summaries).

At step 404, process 400 (e.g., using one or more components described above) generates a similarity matrix related to a first modality. For example, the system may generate a similarity matrix related to a first modality (e.g., first domain) of first user data comprising a set of similarity vectors. Each similarity vector of the set of similarity vectors may include a set of first-modality-similarity metrics (e.g., first-domain-similarity values) between (i) a first embedding of a first set of embeddings and (ii) a second embedding of the first set of embeddings. The first embedding may be based on a summary (e.g., digest) of a first user's actions of a first set of users and the second embedding may be based on a summary (e.g., digest) of a second user's actions of the first set of users. For example, the system may generate the similarity matrix that is related to the first modality of first user data in a manner that is similar to, or the same as similarity matrix 202 (FIG. 2A). By doing so, the system improves generation of textual summaries by determining the similarity between summaries of users to be used as a basis for generating a new summary for the new user.

In one use case, referring to FIG. 2A, the system may generate a similarity matrix 202 related to a first modality of user data (e.g., summaries of user financial account activity). To do so, the system may generate embeddings of each summary of the set of summaries of the first user data. By doing so, the embeddings provide a normalized structure when determining similarity between textual data. Additionally, the embeddings reduce the amount of computational resources required to compare a set of summaries to each other as the embeddings are fixed-length, condensed, representations of a textual summaries of a user's account activity. The similarity matrix 202 may include first-modality-similarity metrics. For example, second similarity matrix 202b shows first-modality-similarity metrics between embeddings of respective user's (e.g., first user 204a, second user 204b, third user 204c, and n-th user 204n) summaries of financial account activities. Second similarity matrix 202b may include a set of similarity vectors, where each similarity vector corresponds to a respective user of the first set of users. For example, the rows of second similarity matrix 202b may indicate a similarity vector of second similarity matrix 202b that corresponds to a respective user. For instance, a first similarity vector of second similarity matrix 202b that corresponds to first user 204a may include (i) first first-modality-similarity metric between first user 204a and first user 204a, (ii) second first-modality-similarity metric between first user 204a and second user 204b, (i) third first-modality-similarity metric between first user 204a and third user 204c, and (i) n-th first-modality-similarity metric between first user 204a and n-th user 204n. In some embodiments, the columns of second similarity matrix 202b may indicate a similarity vector of second similarity matrix 202b that corresponds to a respective user. Each of the first-modality similarity metrics of second similarity matrix 202b may indicate a level of similarity between the embeddings of summaries of the first set of users (e.g., first user 204a, second user 204b, third user 204c, and n-th user 204n) financial account activity. By doing so, the system determines summaries of one user that are similar to other summaries of other users to be used when generating a new summary for a new user.

In some embodiments, the system may receive a first set of embeddings from an artificial intelligence model. For example, the system may obtain from a user data database, the first user data of the first modality. The first user data may include a set of summaries that each summarize a set of user actions. For instance, the set of user actions may be a sequence of actions that the user has performed over a time period. In one use case, the first user data may include summaries of a set of user's account activity, where each summary is a textual description of the user's account (e.g., financial account, bank account, etc.) activity.

The system may populate an artificial intelligence model prompt with (i) an instruction to generate embeddings of the summaries and (ii) the first user data (e.g., the set of summaries). For example, to synchronize data of the first modality to a second modality of user data, the system may first optimize the first user data (e.g., of the first modality) to a common format to which the second user data (e.g., of the second modality) will be in. The system may, for example, populate a Large Language Model (LLM) prompt with an instruction to generate a set of embeddings that each correspond to a summary of the first user data.

For example, the LLM prompt may be a predetermined prompt including one or more data fields to be populated with (i) the instruction to generate the set of embeddings and (ii) the set of summaries. In some embodiments, the LLM may be configured (e.g., trained) to generate an embedding of each summary, such that there is one embedding per summary of the set of summaries that each correspond to a user's actions of a first set of users. As such, the LLM may generate the first set of embeddings such that the first set of embeddings are embeddings that are in a first-modality-space. The system may then provide the populated LLM prompt to the LLM to generate the first set of embeddings, and the system may receive (e.g., from the LLM) the first set of embeddings. By doing so, the system may reduce utilization of computer memory required to store the set of summaries by generating the set of embeddings corresponding to each summary of the set of summaries.

At step 406, process 400 (e.g., using one or more components described above) generates a similarity vector related to a second modality. For example, in response to generating the similarity matrix, the system may generate a similarity vector related to a second modality (e.g., second domain) of second user data. The similarity vector related to the second modality of second user data may include a set of second-modality-similarity metrics (e.g., second-domain-similarity values) between (i) the first embedding of the first user's actions and (ii) a second embedding of a second set of embeddings that correspond to a respective user's actions of the first set of users. For example, the system may generate the similarity vector related to the second modality in a manner similar to or the same as similarity vector 206 (FIG. 2B). By doing so, the system may determine a set of similar users that are similar to the first user to then be used for determining a set of similar summaries for the first user. That is, when employing implied-fusion of one modality to a second modality, the system may leverage a relationship between the different modalities to reduce the amount of computational resources conventionally expended during multimodal data fusion, while improving the generation of textual summaries.

In one use case, the similarity vector may be related to sets of actions of users. For example, referring to FIG. 2B, the system may generate second similarity vector 206b. For example, a similarity vector corresponding to the user to whom the summary is to be generated for (e.g., new user 210) may be generated by the system. The system may generate second similarity vector 206b such that the second similarity vector corresponds to the new user 210 to whom the summary is to be generated for (e.g., the first user). The second similarity vector may be generated based on embeddings of respective user actions. For instance, the system may generate, via an encoder model (or other embedding model) (i) a first embedding of the first user's actions (e.g., new user 210) and (ii) a set of second embeddings that correspond to respective user's actions of the first set of users (e.g., first user 208a, second user 208b, third user 208c, n-th user 208n). In some embodiments, the encoder model may be the same as or different from the encoder model as described in step 404. The embeddings may represent embeddings of user financial account activities that correspond to the first user and the first set of users. For example, the first user may have financial account activity data that indicates that the first user (e.g., new user 210) has (i) checked their credit score, purchased food from a fast food restaurant, purchased a book from a library, and sent money to their friend. The encoder model may generate an embedding of the first user's set of financial account activity data, where the embedding is an embedding of all of the first user's account activity data. Similarly, the encoder model may generate an embedding of each respective user of the first set of user's financial account activity data (first user 208a, second user 208b, third user 208c, n-th user 208n).

The system may then generate second-modality-similarity metrics between such embeddings. For instance, second similarity vector 206b may correspond to new user 210 where the second similarity vector 206b includes (i) first second-modality-similarity metric between new user 210 and first user 208a, (ii) second second-modality-similarity metric between new user 210 and second user 208b, (i) third second-modality-similarity metric between new user 210 and third user 208c, and (i) n-th second-modality-similarity metric between new user 210 and n-th user 208n. The second-modality-similarity metrics may indicate the similarity between the new user 210's set of financial account activity and each respective user of the first set of users financial account activity. By doing so, the system may determine similar users (e.g., based on the second modality of account activities) to be used to select similar summaries under the relationship that users who have similar actions have similar summaries. In this way, the system may create a basis for implied-fusion of multimodal data.

In some embodiments, the system may receive a second set of embeddings from a second artificial intelligence model. For example, the system may obtain, from the user data database, the second user data. The second user data may include a plurality of sets of user actions, where each set of user actions correspond to actions that a given user of the first set of users have performed. For example, the first user data and the second user data may involve the same users. However, the first user data may include predetermined (e.g., manually created, automatically created, artificial intelligence-based created) summaries of each user's set of actions of the first set of users. On the contrary, the second user data may not include the summaries of user's actions of the first set of users, but rather the set of actions each user of the first set of users has performed. As such, the second user data may be in the second-modality (e.g., due to the formatting of the set of user's actions, being a different category of data, etc.).

In some embodiments, the set of user actions of the second user data may be a sequence of actions that a respective user of the first set of users of the second user data has performed. In one use case where the second user data is a plurality of sets of sequences of actions of the first set of users, the second user data may include a set of user account activity data that corresponds to each user of the first set of users. For example, a first user's sequence of actions may be (i) log into a bank account, (ii) check bank account balance, and (ii) transfer money to a checking account in the amount of $5,000 from a savings account. A second user's sequence of actions may be (i) log into a bank account, (ii) check bank account balance, (iii) purchase an item from a first merchant, and (iv) check credit score. Additionally or alternatively, the second user data may preserve timestamp information of each action of a user's sequence of actions. For example, a timestamp to which a given action occurred at may be tagged to each action of the set of user's actions. In some embodiments, the second user data may be associated with a time period. For example, the time period may be predetermined (e.g., user data collected from the last 30 days, the last two months, the last year, the last five years, etc.). For instance, the second user data may include account activity data corresponding to each user of the first set of users that is within the predetermined time period.

Upon obtaining the second user data from the user data database, the system may provide the plurality of sets of user actions to an encoder model. For example, the encoder model may be trained to generate embeddings of the plurality of sets of user actions. For instance, the encoder model may receive, as input, the plurality of sets of user actions. The encoder model may then generate the second set of embeddings, where each embedding of the second set of embeddings correspond to (i) a user and (ii) the user's actions. In other words, the encoder model may be configured to generate the second set of embeddings such that each embedding represents an embedding of a given user's sequence of actions. The system may then receive, from the encoder model, the second set of embeddings. By doing so, the system may convert the second user data of the second modality into a common format as that of the first user data, thereby providing a standardized format to which generation of new summaries of new users may be based on. Additionally, by doing so, the system reduces the amount of computer memory required to store the second user data by embedding the second user data.

At step 408, process 400 (e.g., using one or more components described above) determines a first set of similar users. For example, the system may determine, from the similarity vector related to the second modality (e.g. second domain), a first set of similar users to the first user based on the set of second-modality-similarity metrics. For instance, the system may determine a first set of similar users to the first user based on the set of second-modality-similarity metrics that satisfy a first threshold similarity metric (e.g., first threshold similarity value). The threshold similarity metric may be satisfied when a second-modality-similarity metric is greater than or equal to the threshold similarity metric. By doing so, the system may determine a set of similar users that are similar to the first user (e.g., the new user) to which a summary is to be generated for. In this way, the system may use the first set of similar users to determine a set of similarity vectors related to the first modality to be used when generating a new summary for the first user.

In some embodiments, the system may determine the first set of similar users based on a threshold similarity metric. For example, the system may obtain the similarity vector related to the second modality of second user data. The system may then determine, based on the set of second-modality-similarity metrics of the similarity vector, a subset of the set of second-modality-similarity metrics. For example, the subset of the set of second-modality-similarity metrics may include second-modality-similarity metrics that satisfy a second threshold similarity metric. The second threshold similarity metric may be a predetermined similarity metric (e.g., predetermined percentage, decimal, numerical value, etc.), or may be a user inputted similarity metric threshold (e.g., via a user request or user input indicating the threshold similarity metric).

For example, the system may parse the similarity vector related to the second modality of second user data to identify a subset of second-modality-similarity metrics that satisfy the second threshold similarity metric. For example, the second threshold similarity metric may be satisfied where a second-modality-similarity metric is greater than or equal to the second threshold similarity metric. The system may determine the subset of the set of second-modality-similarity metrics by selecting each second-modality-similarity metric that is greater than or equal to the second threshold similarity metric, thereby forming the subset of the set of second-modality similarity metrics. As each second-modality-similarity metric indicates a similarity metric between (i) the first user's set of actions (e.g., to which a new summary is to be generated based on) and (ii) a respective user of the first set of users set of actions, the subset of second-modality-similarity metrics may represent a set of “most similar” user's actions with respect to the first user. In other words, the system determines which users of the second user data are the most similar to the first user based on the actions (e.g., sequence of actions) that the users have performed.

Referring to FIG. 2C, the system may determine the first set of similar users (e.g., set of similar users 212) based on second-modality-similarity metrics of the generated similarity vector (e.g., second similarity vector 206b) satisfying a threshold similarity metric. The threshold similarity metric may be satisfied when a second-modality-similarity metric is greater than or equal to the threshold similarity metric. As an example, the system may parse through the second similarity vector 206b to determine whether respective second-modality-similarity metrics satisfy the threshold similarity metric. In this is example, where the threshold similarity metric is 0.8 the second-modality-similarity metrics between new user 210 and (i) first user 208a and (ii) second user 208b satisfy the threshold similarity metric.

The system may then identify, based on user identifier labels associated with the subset of the set of second-modality-similarity metrics, the first set of similar users to the first user. For example, the similarity vector (or alternatively, the second-modality-similarity metrics) may be labeled (e.g., tagged) with user identifiers indicating which users are considered when a second-modality-similarity metric is generated. For example, since the similarity vector related to the second modality of second user data indicates similarity metrics between (i) the user to which a new summary is to be generated and (ii) the first set of users, based on the respective users'actions, the similarity vector may maintain labels that identify which user of the first set of user's a respective second-modality-similarity metric is associated with. By doing so, the system may identify which users of the first set of users are similar to that of the first user based on those users that satisfy a threshold similarity metric. In this way, the system may identify similar users to the first user based on the actions that they have performed, which may then be synchronized with another modality of user data (e.g., the summaries) to generate a new summary for the first user.

In some embodiments, the system may determine the first set of similar users based on an ordered set of second-modality-similarity metrics. For example, the system may obtain the similarity vector related to the second modality of second user data. The system may then generate an ordered set of second-modality-similarity metrics based on the set of second modality-similarity metrics. For example, the ordered set of second-modality-similarity metrics may be ordered in a descending order with respect to each second-modality-similarity metric of the set of second second-modality-similarity metrics.

The system may then select from the ordered set of second-modality-similarity metrics, a subset of the ordered set of second-modality-similarity metrics. For example, the subset of the ordered set of second-modality-similarity metrics may satisfy a count condition. The count condition may be a predetermined count condition (e.g., a top number, an amount, a value, etc.) or may be a user-provided (e.g., user inputted via a request, etc.) count condition. The count condition may specify an amount of items that can be part of the subset of the ordered set of second-modality-similarity metrics. For example, the count condition may indicate “top 10,” meaning that the subset of the ordered set of second-modality-similarity metrics may include the top 10 most similar second-modality-similarity metrics. Because the second-modality-similarity metrics are ordered in descending order, the system may parse the ordered set of second-modality-similarity metrics and select the first 10 second-modality-similarity metrics to form the subset of the ordered set of second-modality-similarity metrics.

Similar to that as described above, the system may then identify, based on the user identifier label associated with the subset of the ordered set of second-modality-similarity metrics, the first set of similar users to the first user. By determining the first set of similar users to the first user based on the subset of the ordered set of second-modality-similarity metrics satisfying the count condition, the system may filter out non-similar users by selecting only the most similar users in the second-modality.

In some embodiments, the system may determine the first set of similar users based on a threshold similarity metric and a count metric. For example, as discussed above, the system may determine, based on the set of second modality-similarity metrics of the similarity vector, a subset of the set of second-modality-similarity metrics, where each second-modality-similarity metric of the subset of the set of second-modality-similarity metrics satisfies a second threshold similarity metric. However, to further filter down the second-modality-similarity metrics to obtain a most accurate set of similar users to the first user based on their respective actions, the system may select a second subset of the set of second-modality-similarity metrics.

For example, the system may select from the subset of the set of second-modality-similarity metrics, a second subset of the set of second-modality-similarity metrics, where the second subset of the set of second-modality-similarity metrics satisfy a count condition. For example, the count condition may be the same as or similar to that as described above (e.g., top 10). The system may then determine, based on user identifier labels associated with the second subset of the set of second-modality-similarity metrics, the first set of similar users to the first user.

For example, to reduce the amount of computer processing power when determining which users are similar to the first user, in cases where the subset of the set of second-modality-similarity metrics are exceed a predetermined value (e.g. 20, 40, 50, etc.) similarity metrics, the system may filter the subset of second-modality-similarity metrics. For instance, although each second-modality-similarity metric of the subset of the set of second-modality-similarity metrics may satisfy the second threshold similarity metric, there may exist a large number of similarity metrics. When this number is satisfied (e.g., the subset of second-modality-similarity metric includes more than the predetermined value of similarity metrics), the system may select a second subset of the set of second-modality-similarity metrics from the subset of the set of second-modality-similarity metrics that satisfy a count threshold. For example, the system may select the top 10 most similar second-modality-similarity metrics from the subset of the set of second-modality-similarity metrics to reduce the amount of computer processing power utilized when determining a set of users most similar to the first user.

Upon selecting the second subset of the set of second-modality-similarity metrics, the system may determine, based on user identifier labels associated with the second subset of the set of second-modality-similarity metrics, the first set of similar users to the first user.

At step 410, process 400 (e.g., using one or more components described above) determines a set of similarity vectors from the similarity matrix. For example, the system may select, based on the first set of similar users to the first user, a set of similarity vectors from the similarity matrix related to the first modality (e.g., first domain) that correspond to each similar user of the first set of similar users to the first user based on the set of second-modality-similarity metrics (e.g., second-domain-similarity values). For instance, the system may select the set of similarity vectors from the similarity matrix related to the first modality by using the user identifiers associated with the first set of similar users determined based on the similarity vector related to the second modality. By doing so, the system may fuse the second modality of user data to the first modality of user data, thereby reducing utilization of computational resources as compared to existing system's reliance on multiple machine learning model architecture/fusion techniques.

In some embodiments, the system may select the set of similarity vectors based on user identifier labels. For example, the system may obtain a set of user identifier labels corresponding to the first set of similar users to the first user. For example, each similar user of the first set of similar users may be associated with a user identifier label. The user identifier label may indicate a first name, last name, first name last name combination, account identifier number (e.g., PAN, routing number, account number, etc.), a login name, a screen name, or other information that uniquely identifies a user.

Because the first set of similar users are based on the sequence of actions that each user of the first set of similar users has performed with respect to the first user, the system may leverage this information to synchronize or otherwise fuse the second-modality to the first-modality of user information using implied-fusion. To achieve this, the system retrieves the similarity matrix related to the first modality. The system may then select the set of similarity vectors from the similarity matrix related to the first modality based on a match. For example, the system may identify a match between (i) a first user identifier label of the set of user identifier labels (e.g., of the first set of similar users) and (ii) a second user identifier label of a second set of user identifier labels associated with the similarity matrix.

For example, referring back to FIG. 2C, the system may obtain the set of user identifier labels corresponding to the first set of similar users to the first user (e.g., set of similar users 212) from the generated similarity vector related to the second modality (e.g., second similarity vector 206b). The system may then use the obtained set of user identifier labels to select a set of similarity vectors 214 from the second similarity matrix 202b related to the first modality. For example, the system may parse the similarity vector 206b to determine match between the obtained set of user identifier labels corresponding to the set of similar users 212 and user identifier labels of the second similarity matrix 202b to determine the set of similarity vectors 214.

At step 412, process 400 (e.g., using one or more components described above) determines a set of similar summaries. For example, the system may determine a set of similar summaries based on the selected set of similarity vectors. The set of similar summaries may be associated with a first-modality-similarity metric that satisfies a threshold similarity metric. For example, the first-modality-similarity metric may be satisfied when greater or equal to the threshold similarity metric. The system may determine the set of similar summaries using the first-modality-similarity metrics of the selected set of similarity vectors to be used when generating a new summary for a new user. For example, as described above, the system may leverage implied fusion (e.g., users having similar actions have similar summaries of those actions) to determine the set of similar summaries. Such determined set of similar summaries may then be used to form a basis for generating a new summary for a new user. For instance, to improve generation of textual summaries (e.g., improve accuracy of generating a summary for a new user), the system may determine a set of similar summaries to be provided as input to an artificial intelligence model to generate the new summary for the new user (e.g., based on an aggregation of, a summary of, etc.) the determined set of similar summaries. In this way, a new summary for the new user may be generated that is keyed to the new user (e.g., as opposed to merely selecting the most similar summary of the set of similar summaries).

In some embodiments, the system may determine the set of similar summaries based on first modality-similarity metrics satisfying the first threshold similarity metric. For example, the system may select, based on the first set of similar users to the first user, a subset of similarity vectors from the similarity matrix related to the first modality that corresponds to each similar user of the first set of similar users to the first user. As an example, referring to FIG. 2C, the system may select the set of similarity vectors 214 from the second similarity matrix 202b, as the selected set of similarity vectors 214 corresponds to each similar user of the set of similar users 212. The system may then compare, for each similarity vector of the subset of similarity vectors (e.g., set of similarity vectors 214), each first-modality-similarity metric of the subset of similarity vectors to a second threshold similarity metric. For example, the second threshold similarity metric may be a predetermined or user selected threshold similarity metric. The second threshold similarity metric may be a value (e.g., a decimal, ratio, percentage, alphanumeric, etc.). For example, a first-modality-similarity metric may satisfy the second threshold similarity metric when greater than or equal to second threshold similarity metric. In response to the comparison indicating that a respective first-modality-similarity metric of the subset of similarity vectors satisfy the second threshold similarity metric, the system may add a corresponding summary to a set of similar summaries.

For instance, the system may obtain the first-modality similarity metrics from each selected set of similarity vectors by parsing through each similarity vector of the selected set of similarity vectors 214 to determine first-modality-similarity metrics that satisfy the second threshold similarity metric. For example, the second threshold similarity metric is 0.80, the system may determine, for the row-based similarity vector corresponding to the first user 204a, that (i) the first first-modality similarity metric between first user 204a and first user 204a (e.g., having a value of 1), (ii) the second first-modality similarity metric between the first user 204a and second user 204b (having a value of 0.95), and (iii) the third first-modality similarity metric between first user 204a and n-th user 204n (e.g., having a value of 0.84) satisfy the second threshold similarity metric. The system may then determine user identifier labels associated with the respective first-modality-similarity metrics that satisfy the second threshold similarity metric. For example, the system may determine the user identifier labels corresponding to the first user 204a, the second user 204b, and the n-th user 204n. The system may then determine the set of similar summaries based on retrieving summaries of the first user data corresponding to the determined user identifier labels. For example, the system may parse a database (e.g., summary database) to determine a match between the user identifier labels corresponding to the first user 204a, the second user 204b, and the n-th user 204n. Upon determining a match, the system may retrieve the summaries corresponding to the user identifier labels.

In some embodiments, the system may determine the set of similar summaries further based on a count condition. For example, the system may obtain from each similarity vector of the selected set of similarity vectors, the first-modality-similarity metrics that correspond to the respective similarity vectors of the selected set of similarity vectors. For example, the system may obtain the first-modality-similarity metrics of the selected set of similarity vectors 214. The system may then determine user identifier labels associated with the respective first-modality-similarity metrics that satisfy both (i) the second threshold similarity metric and (ii) the count condition. For example, the count condition may be a “top 2,” “top 5,” or “top N” condition. In other words, the system may determine first-modality-similarity metrics based on the predetermined condition (e.g., a predetermined amount of first-modality-similarity metrics). For instance, where the count condition is “top 2,” the system may select the two highest first-modality-similarity metrics from the selected set of similarity vectors 214. The system may then determine the set of similar summaries based on retrieving summaries of the first user data corresponding to the determined user identifiers that satisfy both (i) the second threshold similarity metric and/or (ii) the count condition. In this way, the system may determine the most similar summaries in which to base generation of a new summary for a new user on.

At step 414, process 400 (e.g., using one or more components described above) generates a summary (e.g., digest) based on the set of similar summaries. For example, the system may generate the summary (e.g., digest) of the first user's actions based on providing the set of similar summaries as input to an artificial intelligence model trained to generate summaries of textual data. The artificial intelligence model may be a LLM (e.g., a transformer model) or other artificial intelligence model trained to input and output textual data. By doing so, the system may generate a new summary that is keyed to the new user based on implied-fusion of one modality of user data to another modality of user data.

For example, in some embodiments, the system may populate an artificial intelligence model prompt with an instruction to generate a summary based on a set of similar summaries. For example, the LLM prompt may be a predetermined prompt including one or more data fields to be populated with (i) the instruction to generate the summary and (ii) the set of similar summaries. In some embodiments, the LLM may be configured (e.g., trained) to generate a new summary using the set of similar summaries as a basis for the new summary. For instance, the LLM may be pre-trained to condense or otherwise summarize a dataset. The system may leverage the implied relationship of users that perform similar actions have similar summaries. However, to ensure accurate generation of a summary for a new user, the system generates a new summary for the user based on the set of similar summaries as opposed to merely selecting a pre-generated summary that is most similar to the new user based on the new user's actions. That is, while the set of similar summaries may be used as a base to generate a new summary for the new user, such set of similar summaries are nonetheless still directly associated with the original users (e.g., the first set of users). Therefore, to generate a unique summary for the new user, the system may leverage the LLM to generate a summary that uses the data of the set of similar summaries, to generate a generalized summary that is keyed to the new user.

In some embodiments, the system may provide (i) the set of similar summaries and (ii) the set of first-modality-similarity metrics corresponding to the set of similar summaries to the LLM to generate the new summary. For example, the LLM prompt may additionally include data fields to accept the first-modality-similarity metrics associated with the set of similar summaries. In this way, the system may provide the LLM with additional information indicating which summaries of the set of similar summaries to afford more weight to, thereby improving generation of textual summaries.

In some embodiments, the system may transmit a message to a user device associated with the first user. For example, to provide the user (e.g., first user, new user, etc.) with a requested summary of their actions, the system may generate a notification including the summary of the user's actions. The system may then transmit the notification to the user device associated with the first user. For example, the system may transmit the notification to the user device via SMS, email, Bluetooth, the Internet, or via other communication methods. By doing so, the system may provide the summary to the user in real-time.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method, the method comprising: in response to receiving a request to generate a digest of a first user's actions of a first user over a first secure computing network, generating a first encoding of the first user's actions via an encoder model; generating a similarity matrix related to a first domain of first user data comprising a set of similarity vectors, wherein each similarity vector of the set of similarity vectors comprises a set of first-domain-similarity values between (i) a first encoded-domain of a first set of encodings and (ii) a second encoding of the first set of encodings, wherein the first encoding is based on a digest of a first user's actions of a first set of users and the second encoding is based on a digest of a second user's actions of the first set of users; in response to generating the similarity matrix, generating a similarity vector related to a second domain of second user data comprising a set of second-domain-similarity values between (i) the first encoding of the first user's actions and (ii) a second encoding of a second set of encodings that correspond to a respective user's actions of the first set of users; determining, from the similarity vector related to the second domain, a first set of similar users to the first user based on the set of second-domain-similarity values; selecting, based on the first set of similar users to the first user, a set of similarity vectors from the similarity matrix related to the first domain that correspond to each similar user of the first set of similar users to the first user based on the set of second-domain-similarity values; determining a set of similar digests, based on the selected set of similarity vectors, wherein the set of similar digests are associated with a first-domain-similarity value satisfying a first threshold similarity value; and generating the digest of the first user's actions based on providing the set of similar digests as input to an artificial intelligence model trained to generate digests of textual data.
2. The method of any one of the preceding embodiments, further comprising: generating a message comprising the digest of the first user's actions; and transmitting the message to a user device associated with the first user.
3. The method of any one of the preceding embodiments, wherein the first domain indicates a first category of the first user data, and wherein the second domain indicates a second category of the second user data, wherein the first category is different than the second category.
4. The method of any one of the preceding embodiments, wherein the first domain indicates a first format of the first user data, and wherein the second domain indicates a second format of the second user data, wherein the first format is different than the second format.
5. The method of any one of the preceding embodiments, wherein the first domain indicates a first dimensionality of the first user data, and wherein the second domain indicates a second dimensionality of the second user data, wherein the first dimensionality is different than the second dimensionality.
6. The method of any one of the preceding embodiments, further comprising: obtaining, from a user data database, the first user data comprising a set of digests of user actions, wherein each digest of the set of digests correspond to a given user and actions that the given user has performed; populating a Large Language Model (LLM) prompt with (i) an instruction to generate a set of encodings and (ii) the set of digests; and receiving, from an LLM trained to generate encodings, the first set of encodings based on providing the populated LLM prompt to the LLM.
7. The method of any one of the preceding embodiments, further comprising: obtaining, from a user data database, the second user data comprising a plurality of sets of user actions, wherein each set of user actions correspond to actions that a given user has performed; and receiving the second set of encodings, based on providing the plurality of sets of user actions to the encoder model, from the encoder model.
8. The method of any one of the preceding embodiments, wherein determining the first set of similar users to the first user further comprises: obtaining the similarity vector related to the second domain of second user data; determining, based on the set of second-domain-similarity values of the similarity vector, a subset of the set of second-domain-similarity values, wherein each second-domain-similarity value of the subset of the set of second-domain-similarity values satisfies a second threshold similarity value; and determining, based on user identifier labels associated with the subset of the set of second-domain-similarity values, the first set of similar users to the first user.
9. The method of any one of the preceding embodiments, wherein determining the first set of similar users to the first user further comprises: obtaining the similarity vector related to the second domain of second user data; generating an ordered set of second-domain-similarity values, based on the set of second-domain-similarity values, in descending order; selecting, from the ordered set of second-domain-similarity values, a subset of the ordered set of second-domain-similarity values, wherein the subset of the ordered set of second-domain-similarity values satisfy a count condition; and determining, based on user identifier labels associated with the subset of the ordered set of second-domain-similarity values, the first set of similar users to the first user.
10. The method of any one of the preceding embodiments, wherein determining the first set of similar users to the first user further comprises: obtaining the similarity vector related to the second domain of second user data; determining, based on the set of second-domain-similarity values of the similarity vector, a subset of the set of second-domain-similarity values, wherein each second-domain-similarity value of the subset of the set of second-domain-similarity values satisfies a second threshold similarity value; selecting, from the subset of the set of second-domain-similarity values, a second subset of the set of second-domain-similarity values, wherein the second subset of the set of second-domain-similarity values satisfy a count condition; and determining, based on user identifier labels associated with the second subset of the set of second-domain-similarity values, the first set of similar users to the first user.
11. The method of any one of the preceding embodiments, wherein selecting the set of similarity vectors from the similarity matrix related to the first domain further comprises: obtaining a set of user identifier labels corresponding to the first set of similar users to the first user; retrieving the similarity matrix related to the first domain; and selecting the set of similarity vectors from the similarity matrix related to the first domain in response to identifying a match between (i) a first user identifier label of the set of user identifier labels and (ii) a second user identifier label of a second set of user identifier labels associated with the similarity matrix, wherein each similarity vector of the set of similarity vectors of the similarity matrix is associated with a user identifier label indicating a user of the first set of users.
12. The method of any one of the preceding embodiments, wherein determining the set of similar digests further comprises: obtaining, for each similarity vector of the selected set of similarity vectors, the set of first-domain-similarity values that correspond to the respective similarity vector of the selected set of similarity vectors; for each first-domain-similarity value of the set of first-domain-similarity values that correspond to the respective similarity vector of the selected set of similarity vectors that satisfy the first threshold similarity value, determining a second user identifier label associated with the respective first-domain-similarity value satisfying the first threshold similarity value; and determining the set of similar digests based on retrieving digests of the first user data corresponding to the determined second user identifier.
13. The method of any one of the preceding embodiments, wherein determining the set of similar digests further comprises: obtaining, for each similarity vector of the selected set of similarity vectors, the set of first-domain-similarity values that correspond to the respective similarity vector of the selected set of similarity vectors; for each first-domain-similarity value of the set of first-domain-similarity values that correspond to the respective similarity vector of the selected set of similarity vectors that satisfy both (i) the first threshold similarity value and (ii) a count condition, determining a second user identifier label associated with the respective first-domain-similarity value satisfying both (i) the first threshold similarity value and (ii) the count condition; and determining the set of similar digests based on retrieving digests of the first user data corresponding to the determined second user identifier.
14. The method of any one of the preceding embodiments, further comprising: obtaining first user data of the first domain and second user data of the second domain, wherein (i) the first user data of the first domain comprises a set of digests each digesting a sequence of actions of a respective user of a first set of users, and (ii) the second user data of the second domain comprises, for each user of the first set of users, a respective sequence of actions; generating, based on the first user data, via a first artificial intelligence model, the first set of encodings; and generating, based on the second user data, via a second artificial intelligence model, the second set of encodings.
15. The method of any one of the preceding embodiments, wherein the digest is a summary.
16. The method of any one of the preceding embodiments, wherein the first domain is a first modality, and wherein the second domain is a second modality.
17. The method of any one of the preceding embodiments, wherein the first encoding is a first embedding, the second encoding is a second embedding, the first set of encodings is a first set of embeddings, and the second set of encodings is a second set of encodings.
18. The method of any one of the preceding embodiments, wherein the first-domain-similarity values are first-modality-similarity metrics, and the second-domain-similarity values are second modality-similarity metrics.
19. The method of any one of the preceding embodiments, wherein the set of similar digests are a set of similar summaries.
20. The method of any one of the preceding embodiments, wherein the first threshold similarity value is a first threshold similarity metric, and the second threshold similarity value is a second threshold similarity metric.
21. One or more non-transitory, computer-readable mediums storing instructions that, when executed by a data processing apparatus, cause the data processing apparatus to perform operations comprising those of any of embodiments 1-20.
12. A system comprising one or more processors; and memory storing instructions that, when executed by the processors, cause the processors to effectuate operations comprising those of any of embodiments 1-20.
23. A system comprising means for performing any of embodiments 1-20.

What is claimed is:

1. A system for generating digests based on computer-generated encodings of incompatible domains via implied-fusion, the system comprising:
one or more processors; and
a non-transitory computer-readable medium comprising instructions that, when executed by one or more processors, cause operations comprising:
in response to receiving a request to generate a digest of a first user's sequence of actions over a first secure computing network, generating, via an encoder model, a first encoding of the first user's actions by providing the first user's sequence of actions as input to the encoder model;
obtaining first user data of a first domain and second user data of a second domain, wherein (i) the first user data of the first domain comprises a set of digests each summarizing a sequence of actions of a respective user of a first set of users, and (ii) the second user data of the second domain comprises, for each user of the first set of users, a respective sequence of actions;
generating a similarity matrix, for the first domain of first user data, comprising a set of similarity vectors, wherein each similarity vector of the set of similarity vectors comprises a set of first-domain-similarity values between (i) a first encoding of a first digest summarizing a user's sequence of actions of the first set of users and (ii) a second encoding of a second digest summarizing another user's sequence of actions of the first set of users;
generating a similarity vector, for the second domain of second user data, comprising a set of second-domain-similarity values between (i) the first encoding of the first user's sequence of actions and (ii) a second encoding of a given user's sequence of actions of the first set of users;
determining, from the similarity vector for the second domain, a first set of similar users to the first user based on the set of second-domain-similarity values satisfying a first threshold similarity value;
selecting, based on the first set of similar users to the first user, a subset of similarity vectors from the similarity matrix for the first domain that corresponds to each similar user of the first set of similar users to the first user;
comparing, for each similarity vector of the subset of similarity vectors, each first-domain-similarity value of a first similarity vector of the subset of similarity vectors to a second threshold similarity value;
in response to the comparison indicating that the first-domain-similarity value of the first similarity vector of the subset of similarity vector satisfies the second threshold similarity value, adding the digest to a set of similar digests;
generating the digest of the first user's actions based on providing the set of similar digests as input to an artificial intelligence model trained to generate digests of textual data; and
transmitting, over the secure computer network, a notification comprising the digest of the first user's actions to a user device associated with the first user.

2. A method for generating digests based on computer-generated encodings of incompatible domains via implied-fusion, the method comprising:
in response to receiving a request to generate a digest of a first user's actions of a first user over a first secure computing network, generating a first encoding of the first user's actions via an encoder model;
generating a similarity matrix related to a first domain of first user data comprising a set of similarity vectors, wherein each similarity vector of the set of similarity vectors comprises a set of first-domain-similarity values between (i) a first encoded-domain of a first set of encodings and (ii) a second encoding of the first set of encodings, wherein the first encoding is based on a digest of a first user's actions of a first set of users and the second encoding is based on a digest of a second user's actions of the first set of users;
in response to generating the similarity matrix, generating a similarity vector related to a second domain of second user data comprising a set of second-domain-similarity values between (i) the first encoding of the first user's actions and (ii) a second encoding of a second set of encodings that correspond to a respective user's actions of the first set of users;
determining, from the similarity vector related to the second domain, a first set of similar users to the first user based on the set of second-domain-similarity values;
selecting, based on the first set of similar users to the first user, a set of similarity vectors from the similarity matrix related to the first domain that correspond to each similar user of the first set of similar users to the first user based on the set of second-domain-similarity values;
determining a set of similar digests, based on the selected set of similarity vectors, wherein the set of similar digests are associated with a first-domain-similarity value satisfying a first threshold similarity value; and
generating the digest of the first user's actions based on providing the set of similar digests as input to an artificial intelligence model trained to generate digests of textual data.

3. The method of claim 2, further comprising:
generating a message comprising the digest of the first user's actions; and
transmitting the message to a user device associated with the first user.

4. The method of claim 2, wherein the first domain indicates a first category of the first user data, and wherein the second domain indicates a second category of the second user data, wherein the first category is different than the second category.

5. The method of claim 2, wherein the first domain indicates a first format of the first user data, and wherein the second domain indicates a second format of the second user data, wherein the first format is different than the second format.

6. The method of claim 2, wherein the first domain indicates a first dimensionality of the first user data, and wherein the second domain indicates a second dimensionality of the second user data, wherein the first dimensionality is different than the second dimensionality.

7. The method of claim 2, further comprising:
obtaining, from a user data database, the first user data comprising a set of digests of user actions, wherein each digest of the set of digests correspond to a given user and actions that the given user has performed;
populating a Large Language Model (LLM) prompt with (i) an instruction to generate a set of encodings and (ii) the set of digests; and
receiving, from an LLM trained to generate encodings, the first set of encodings based on providing the populated LLM prompt to the LLM.

8. The method of claim 2, further comprising:
obtaining, from a user data database, the second user data comprising a plurality of sets of user actions, wherein each set of user actions correspond to actions that a given user has performed; and
receiving the second set of encodings, based on providing the plurality of sets of user actions to the encoder model, from the encoder model.

9. The method of claim 2, wherein determining the first set of similar users to the first user further comprises:
obtaining the similarity vector related to the second domain of second user data;
determining, based on the set of second-domain-similarity values of the similarity vector, a subset of the set of second-domain-similarity values, wherein each second-domain-similarity value of the subset of the set of second-domain-similarity values satisfies a second threshold similarity value; and
determining, based on user identifier labels associated with the subset of the set of second-domain-similarity values, the first set of similar users to the first user.

10. The method of claim 2, wherein determining the first set of similar users to the first user further comprises:
obtaining the similarity vector related to the second domain of second user data;
generating an ordered set of second-domain-similarity values, based on the set of second-domain-similarity values, in descending order;
selecting, from the ordered set of second-domain-similarity values, a subset of the ordered set of second-domain-similarity values, wherein the subset of the ordered set of second-domain-similarity values satisfy a count condition; and
determining, based on user identifier labels associated with the subset of the ordered set of second-domain-similarity values, the first set of similar users to the first user.

11. The method of claim 2, wherein determining the first set of similar users to the first user further comprises:
obtaining the similarity vector related to the second domain of second user data;
determining, based on the set of second-domain-similarity values of the similarity vector, a subset of the set of second-domain-similarity values, wherein each second-domain-similarity value of the subset of the set of second-domain-similarity values satisfies a second threshold similarity value;
selecting, from the subset of the set of second-domain-similarity values, a second subset of the set of second-domain-similarity values, wherein the second subset of the set of second-domain-similarity values satisfy a count condition; and
determining, based on user identifier labels associated with the second subset of the set of second-domain-similarity values, the first set of similar users to the first user.

12. The method of claim 2, wherein selecting the set of similarity vectors from the similarity matrix related to the first domain further comprises:
obtaining a set of user identifier labels corresponding to the first set of similar users to the first user;
retrieving the similarity matrix related to the first domain; and
selecting the set of similarity vectors from the similarity matrix related to the first domain in response to identifying a match between (i) a first user identifier label of the set of user identifier labels and (ii) a second user identifier label of a second set of user identifier labels associated with the similarity matrix, wherein each similarity vector of the set of similarity vectors of the similarity matrix is associated with a user identifier label indicating a user of the first set of users.

13. The method of claim 2, wherein determining the set of similar digests further comprises:
obtaining, for each similarity vector of the selected set of similarity vectors, the set of first-domain-similarity values that correspond to the respective similarity vector of the selected set of similarity vectors;
for each first-domain-similarity value of the set of first-domain-similarity values that correspond to the respective similarity vector of the selected set of similarity vectors that satisfy the first threshold similarity value, determining a second user identifier label associated with the respective first-domain-similarity value satisfying the first threshold similarity value; and
determining the set of similar digests based on retrieving digests of the first user data corresponding to the determined second user identifier.

14. The method of claim 2, wherein determining the set of similar digests further comprises:
obtaining, for each similarity vector of the selected set of similarity vectors, the set of first-domain-similarity values that correspond to the respective similarity vector of the selected set of similarity vectors;
for each first-domain-similarity value of the set of first-domain-similarity values that correspond to the respective similarity vector of the selected set of similarity vectors that satisfy both (i) the first threshold similarity value and (ii) a count condition, determining a second user identifier label associated with the respective first-domain-similarity value satisfying both (i) the first threshold similarity value and (ii) the count condition; and
determining the set of similar digests based on retrieving digests of the first user data corresponding to the determined second user identifier.

15. The method of claim 2, further comprising:
obtaining first user data of the first domain and second user data of the second domain, wherein (i) the first user data of the first domain comprises a set of digests each digesting a sequence of actions of a respective user of a first set of users, and (ii) the second user data of the second domain comprises, for each user of the first set of users, a respective sequence of actions;
generating, based on the first user data, via a first artificial intelligence model, the first set of encodings; and
generating, based on the second user data, via a second artificial intelligence model, the second set of encodings.

16. One or more non-transitory computer-readable media comprising instructions that, when executed by one or more processors, cause operations comprising:
in response to receiving a request to generate a digest of a first user's actions of a first user, generating (i) a similarity matrix related to a first domain of first user data comprising a set of similarity vectors of first-domain similarity values and (ii) a similarity vector related to a second domain of second user data comprising a set of second-domain-similarity values;
selecting, based on a first set of similar users to the first user using the set of second-domain-similarity values, a set of similarity vectors from the similarity matrix related to the first domain that correspond to each similar user of the first set of similar users;
determining a set of similar digests, based on the selected set of similarity vectors, wherein the set of similar digests are associated with a first-domain-similarity value satisfying a first threshold similarity value; and
generating the digest of the first user's actions based on the set of similar digests.

17. The media of claim 16, wherein the instructions that, when executed by the one or more processors, further cause operations comprising:
generating a message comprising the digest of the first user's actions; and
transmitting the message to a user device associated with the first user.

18. The media of claim 16, wherein determining the first set of similar users to the first user further comprises:
obtaining the similarity vector related to the second domain of second user data;
determining, based on the set of second-domain-similarity values of the similarity vector, a subset of the set of second-domain-similarity values, wherein each second-domain-similarity value of the subset of the set of second-domain-similarity values satisfies a second threshold similarity value; and
determining, based on user identifier labels associated with the subset of the set of second-domain-similarity values, the first set of similar users to the first user.

19. The media of claim 16, wherein selecting the set of similarity vectors from the similarity matrix related to the first domain further comprises:
obtaining a set of user identifier labels corresponding to the first set of similar users to the first user;
retrieving the similarity matrix related to the first domain; and
selecting the set of similarity vectors from the similarity matrix related to the first domain in response to identifying a match between (i) a first user identifier label of the set of user identifier labels and (ii) a second user identifier label of a second set of user identifier labels associated with the similarity matrix, wherein each similarity vector of the set of similarity vectors of the similarity matrix is associated with a user identifier label indicating a user of the first set of users.

20. The media of claim 16, wherein determining the set of similar digests further comprises:
obtaining, for each similarity vector of the selected set of similarity vectors, the first-domain-similarity values that correspond to the respective similarity vector of the selected set of similarity vectors;
for each first-domain-similarity value of the first-domain-similarity values that correspond to the respective similarity vector of the selected set of similarity vectors that satisfy the first threshold similarity value, determining a second user identifier label associated with the respective first-domain-similarity value satisfying the first threshold similarity value; and
determining the set of similar digests based on retrieving digests of the first user data corresponding to the determined second user identifier.
